(19) United States
(12) Patent Application Publication
(10) Pub. No.: US 2021/0114771 A1
(43) Pub. Date: Apr. 22, 2021

(54) Storage tank with fluid transfer

(71) Applicant: Winthrop Innovations, LLC, West Palm Beach, FL (US)

(72) Inventors: Neil Winthrop, West Palm Beach, FL (US); Kimberly Winthrop, West Palm Beach, FL (US); Jake A. Winthrop, West Palm Beach, FL (US)

(21) Appl. No.: 17/006,079

(22) Filed: Aug. 28, 2020

Related U.S. Application Data
(60) Provisional application No. 62/894,745, filed on Aug. 31, 2019.

(51) Int. Cl. B65D 25/42; B65D 25/28; B65D 21/02

(52) U.S. Cl. CPC B65D 25/42; B65D 21/0238; B65D 25/2894

(57) ABSTRACT

A stackable tank that allows fluids to flow from one tank to a succeeding tank through an interconnect coupler having a check-valve allowing the user to safely and conveniently increase the uninterrupted run-time of a generator or other fuel-driven device. For non-fuel applications, the invention creates increased capacity of the desired fluid without the need for multiple refilling or changing of the tanks. The instant invention also minimizes the horizontal footprint for storing multiple tanks and containers.

### CROSS REFERENCE TO RELATED APPLICATION

In accordance with 37 C.F.R. 1.76, a claim of priority is included in an Application Data Sheet filed concurrently herewith. Accordingly, the present invention claims priority to U.S. Provisional Patent Application No. 62/894,745, filed Aug. 31, 2019, entitled “STACKABLE TANKS AND GAS CAP QUICK CONNECT” the contents of which is incorporated herein by reference.

### FIELD OF THE INVENTION

The present invention relates to the field of storage tanks and, in particular, to a portable storage tank that is stackable and allows for fluid transfer.

### BACKGROUND OF THE INVENTION

The need to store fluids is quite common. Gasoline, diesel fuel, aviation fuel, and water are but a few examples of fluids that require storage. For ease of description, this specification will be directed to a storage tank using gasoline as the fluid, although the instant storage tank can be used with most any fluid in need of storage.

Gasoline is one such fuel that is commonly stored in a residential garage for purposes of fueling of an emergency generator, a lawn mower, hedge trimmer, weed trimmer, blower, moped, motorcycle, pressure washer, and anything else that modern society has powered off of an internal combustion engine. The quantity of fuel stored is an individual decision that will likely take into account the amount of fuel the consumer believes they will be using over a short period of time.

For example, a consumer who has a large yard may consume excessive amounts of gasoline for mowing of the lawn and thereby require either sufficient storage of the fuel or frequent trips for refueling. Consumers may also store fuel for emergency purposes. For instance, it is not uncommon for individuals to store gasoline in anticipation of power shortages due to hurricanes or other inclement weather.

Hurricane preparation and the aftermath are indicative of the need to store fuel. During hurricane preparation, a garage is a typical storage location for lawn chairs, garden hose reels, swing sets, planted pots, umbrellas, swimming pool items, play houses, dog houses, landscape lighting and anything else that cannot handle high winds. The need to store fuel is also critical; however, free space within the garage may be at a premium with all the other items stored therein.

A very important example for the storage of sufficient fuel is the need to run a generator after a storm. Hurricanes, tornados, earthquakes, transformer failures, downed power lines and the like can easily cause power losses, which can be devastating to a family. In some instances, the loss of power may be inconvenient, causing the loss of air-conditioning, lights, and television. In other instances, the loss of power can be extremely inconvenient, such as when a family loses their refrigerated food, cannot recharge their telephones, or cannot operate a modem to access the Internet. In still other instances, the loss of power can be catastrophic, such as when a consumer cannot operate a home oxygen system, a dialysis system or access to refrigerated medicine. In such instances, it is paramount that the consumer store sufficient fuel until services can be restored.

Another problem with storing fluid is the transfer from the tank to the unit using the fuel. Using a generator as a further example, a generator could be expected to run days or weeks after a storm. Transferring gasoline from a portable tank into a generator storage tank can be dangerous should gasoline drip over the hot engine. Accidentally overfilling the generator fuel tank can lead to spillage. Still another problem is having to refill the fuel tank before the fuel is exhausted. Shutting off a generator and allowing it to cool before fueling leaves the facilities without electricity for a period of time, and it is always possible that the generator will not restart.

Still another example is the need to transfer fuel on a moving vehicle such as a wave runner. A wave runner can easily run out of fuel as the riders enjoy the fast paced action and can forget to monitor the fuel level. Should the wave runner run out of fuel, attempting to fill from a conventional fuel tank requires a funnel to assist in fuel transfer. This is especially problematic when the water conditions cause excessive movement of the wave runner making it difficult to transfer fuel.

What is needed in the industry is a portable storage tank that can be stacked to save space, used to expand the volume of an existing storage tank, and allow for a leak proof transfer of liquid when used on a moving vehicle.

### SUMMARY OF THE INVENTION

Disclosed is a stackable storage tank that can be placed in series for increasing the volume of the storage tank, and can be placed in a stacked position to lessen the storage space requirements. The use of a coupling cap allows tanks to be attached to a conventional generator, allowing increased storage of fuel.

The stackable tank configuration saves space by allowing multiple tanks to sit vertically atop one another. Each tank has the characteristic of being able to join one another, thereby allowing the fluid to flow by gravity to the main storage area. In the case of multiple tank stacking, each tank would have the ability to flow automatically or manually into the next lower tank through an interconnect device. This would essentially multiply the available fluid supply, thereby minimizing or eliminating a break in service.

When the content of a tank is exhausted or depleted, the tank, which is equipped with a quick-connect check valve, may be removed and refilled for the next use. A combination quick-connect gas cap is incorporated into the design. When the tanks are transported back to the storage site, they may be stacked on each other to conserve space.

An objective of the instant invention is to create a flow-through configuration that prevents unnecessary or inconvenient refueling during times of extended or continued use.

A further objective of the instant invention is to provide a device to safely switch or add tanks, especially for the novice, when using flammable fluids that might ignite or flash when coming in contact with an exhaust manifold or other source of ignition.

Yet another objective of this invention is to be able to easily fill and transport the tanks by using tanks of standard capacity, i.e. one gallon, five gallon, or other capacity that is easily carried and manageable to stack.

Other objectives and advantages of this invention will become apparent from the following description, taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE DRAWINGS

FIG. 1 is a front perspective view of the stackable tank of the instant invention;

FIG. 2 is a rear perspective view thereof;

FIG. 3 is a top plane view thereof;

FIG. 4 is a front plane view thereof;

FIG. 5 is a right side plane view thereof;

FIG. 6 is a bottom plane view thereof;

FIG. 7 is a rear perspective view of the stackable tank positioned on a generator;

FIG. 8 is a right side view of the stackable tank on the generator;

FIG. 9 is a cross-sectional side view of the fuel coupler and generator;

FIG. 10 is an enlarged cross-sectional view of the fuel coupler;

FIG. 11 is a pictorial view depicting two tanks in a stacked fluid transfer position;

FIG. 12 is a side view a tank with caps;

FIG. 13 is an enlarged cross sectional side view of the inlet coupler; and

FIG. 14 is an enlarged cross sectional side view of the check valve.

### DESCRIPTION OF THE PREFERRED EMBODIMENT OF THE INVENTION

Detailed embodiments of the instant invention are disclosed herein; however, it is to be understood that the disclosed embodiments are merely exemplary of the invention, which may be embodied in various forms. Therefore, specific functional and structural details disclosed herein are not to be interpreted as limiting, but merely as a basis for the claims and as a representational basis for teaching one skilled in the art to variously employ the present invention in virtually any appropriately detailed structure.

Referring to the Figures in general, disclosed is a stackable tank 10. The stackable tank 10 may come in various capacities to work in concert with a receiving tank of a specified fluid. For purposes of illustration, the specified fluid herein shall be gasoline. The stackable tank 10 may be used for flammable or other fluids which would allow for tanks of appropriate colors, such as red for flammable, blue for potable water composed of an FDA approved resin, yellow for chlorine or diesel fuel, and so forth.

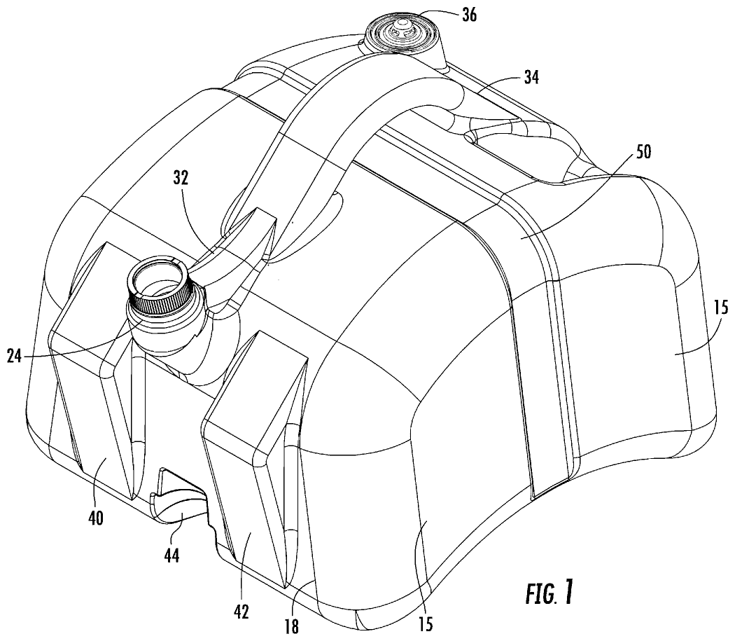

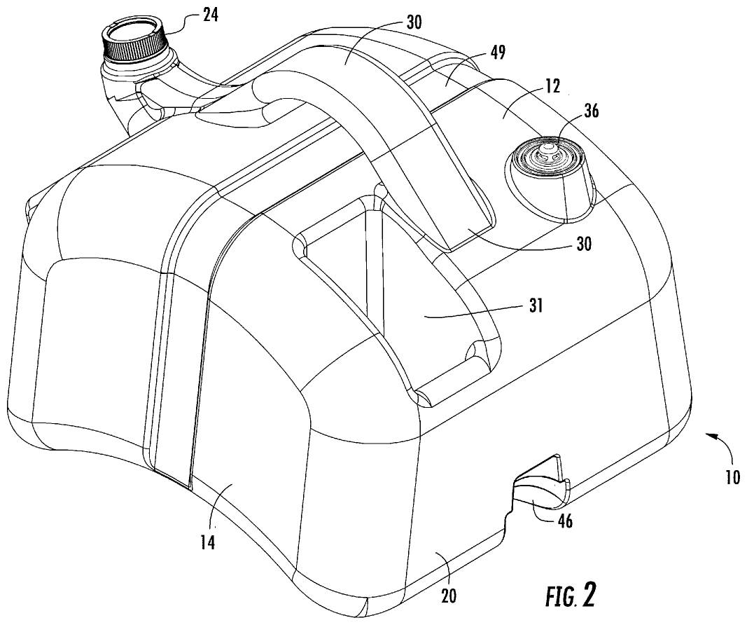

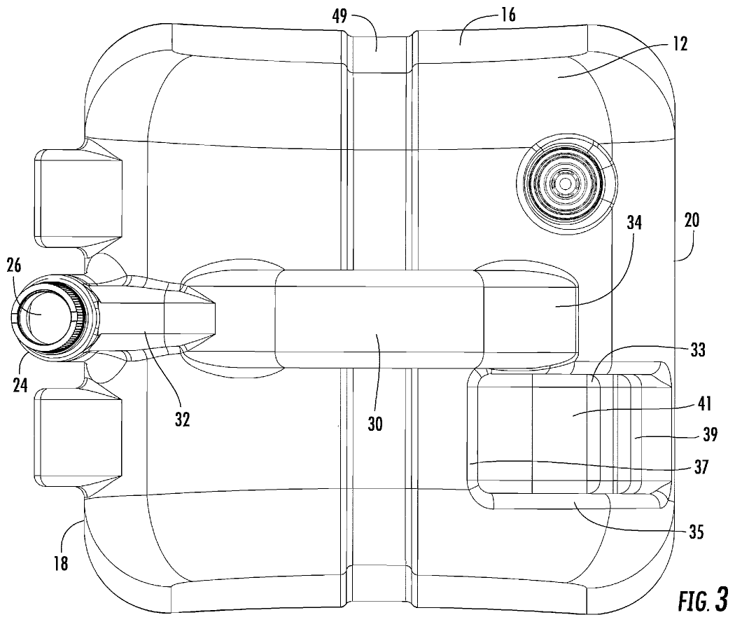

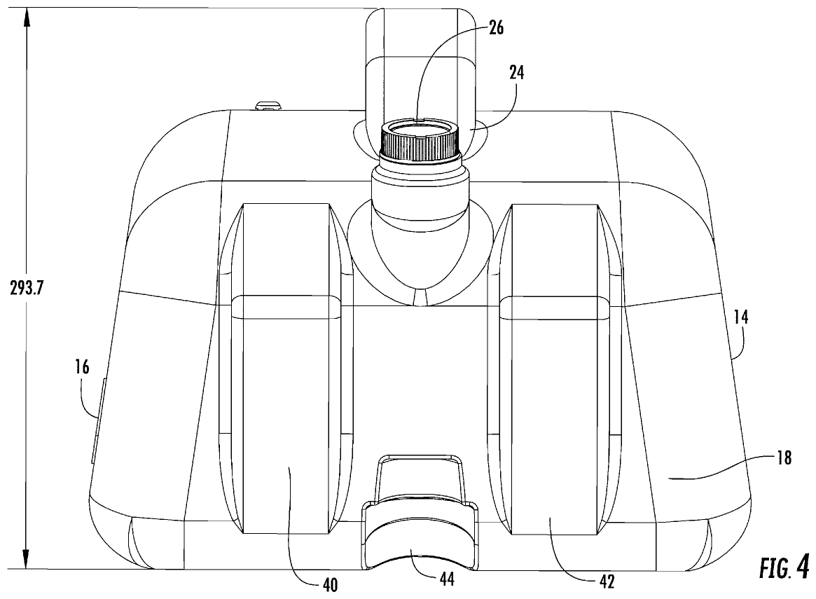

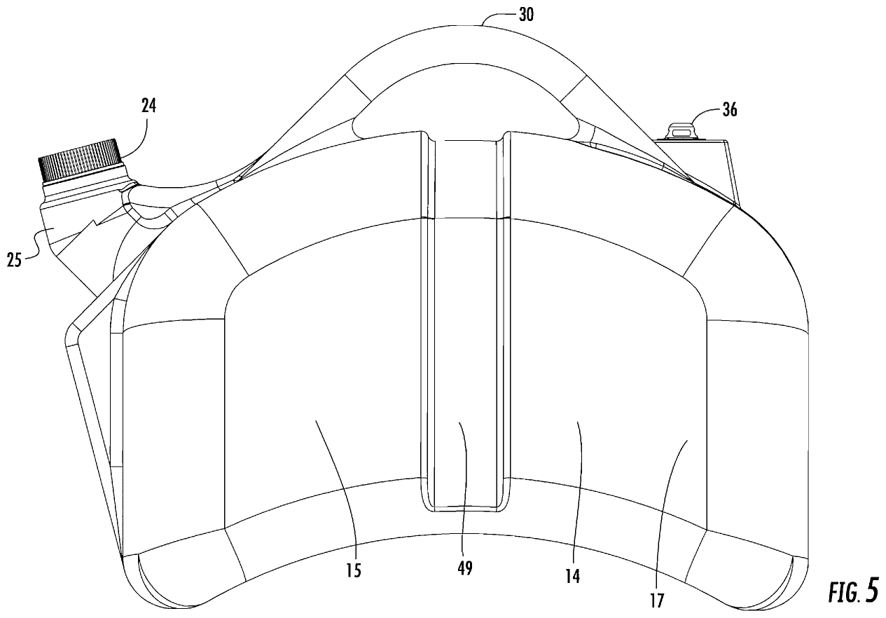

Referring to FIGS. 1-6, illustrated is the stackable tank 10 of the instant invention having a top side 12, a first side wall 14, a second side wall 16, a front wall 18, a rear wall 20, and a bottom side 22. The top side 12 has a convex shape, wherein the overall surface is curved outward. The bottom side 22 has a concave shape wherein the overall surface is curved inward. As illustrated and further described herein, the top side 12 and the bottom side 22 are constructed and arranged to allow stacking of similar shaped tanks 10. The curvature allows stacked tanks to securely nest to one another to allow secure coupling when two tanks are aligning for fuel transfer, as well as secure placement when two tanks are aligned for storage. Protruding from the top side 12 of the tank 10, adjacent to the front wall 18, is a threaded opening 24 illustrated with a threaded cap 26. The threaded opening 24, also referred to later as a fluid fill port 24, is fluidly coupled to an integrated handle 30 by an internal vent 32 that is open to the threaded opening 24 and extends to a distal end 34 of the handle 30, providing an anti-glug tube 45. A quick connect fluid inlet coupler 36 is positioned adjacent to the rear wall 20. Beneath the integrated handle 30 is a recessed area 49 extending traversely across the upper side 12 and extending to the lower side 22 along said first and second side walls 14, 16. The recessed area 49 is for receipt of a strap, not shown, allowing the tank 10 to be physically secured to a base, such as a generator fuel tank or another stackable tank. In one embodiment, a receptacle 31, formed by side walls 33, 35, 37, and 39 with a bottom wall 41, provides a location wherein the consumer can store a container of oil. For instance, if the tank 10 was to be used for gasoline, the receptacle may store a quart of two cycle oil. If the tank 10 was to be used for storage of water, the receptacle 31 may store water flavoring, chlorine fluid, chlorine tablets and so forth.

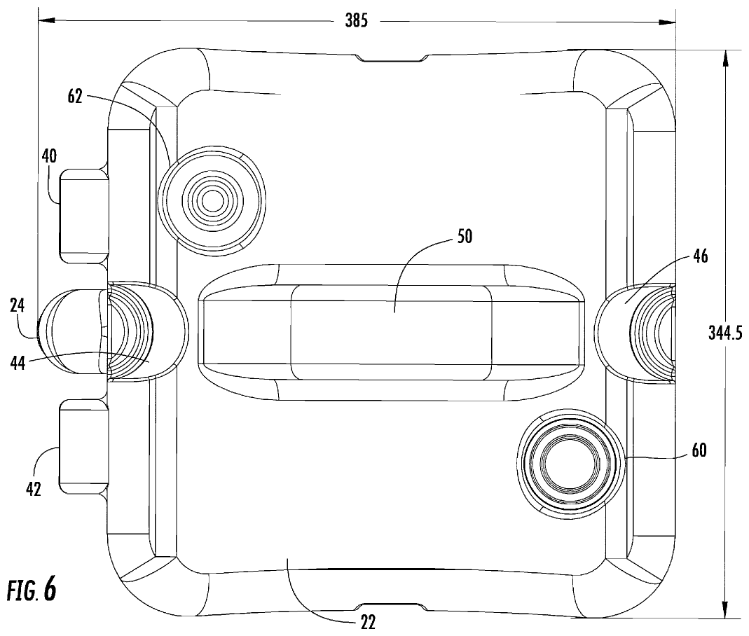

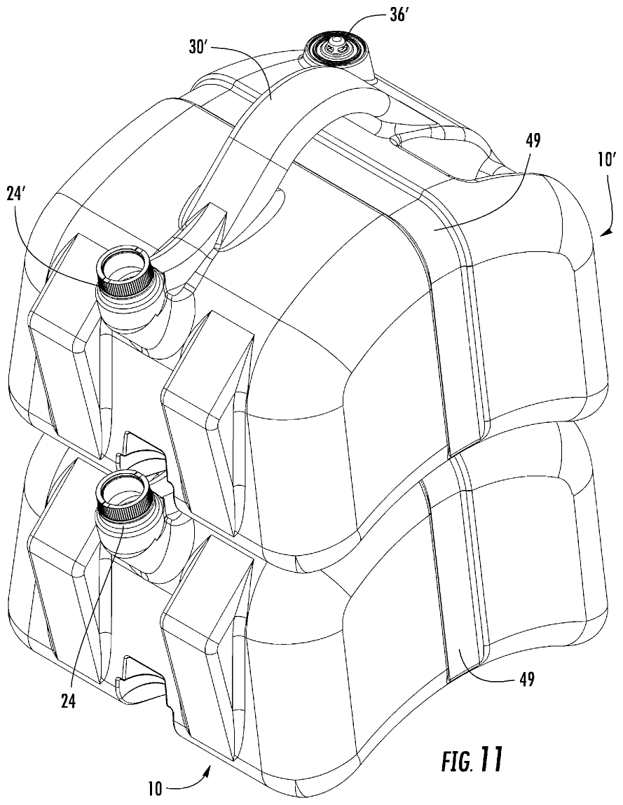

Molded wedges 40, 42 on the front side wall 18 of the tank 10 allow for hands-free pouring of fluid by allowing the tank 10 to rest on the front side wall 18 while fluid is dispensed from the opening 24. A first receiving indent 44 formed along the front side wall 18 and the bottom side 22 is constructed and arranged to allow nesting of a similar tank 10, depicted in FIG. 11, when placed in a stacked fluid transfer position. A second receiving indent 46 formed along the rear side wall 20 and the bottom side 22 allows nesting of a tank 10 in an opposite, or storage, position. Similarly, handle 30 fits within receptacle 50 formed in the bottom side 22, providing directional alignment to a stacked tank 10 by preventing either tank 10 from becoming misaligned. As illustrated in FIG. 6, the bottom side 22 includes a fluid outlet coupler 60 for receipt of a quick connect fluid inlet coupler 36 of an adjoining tank 10. In this configuration, the fluid from an upper tank will flow through the fluid outlet coupler 60 and into a lower tank by means of the quick connect fluid inlet coupler 36 while in the transfer position. The bottom side 22 further includes a receptacle 62 for receipt of a quick connect fluid inlet coupler 36 while the tank 10 is positioned in a storage position. In the storage position, the quick connect fluid inlet coupler 36 will not function, as it is protected from impact by the receptacle 62. In the storage position, the neck 25 of the threaded opening 24 will fit within the second receiving indent 46. First side wall 14 may include Imperial volume indicia markings 15 and Metric volume indicia markings 17.

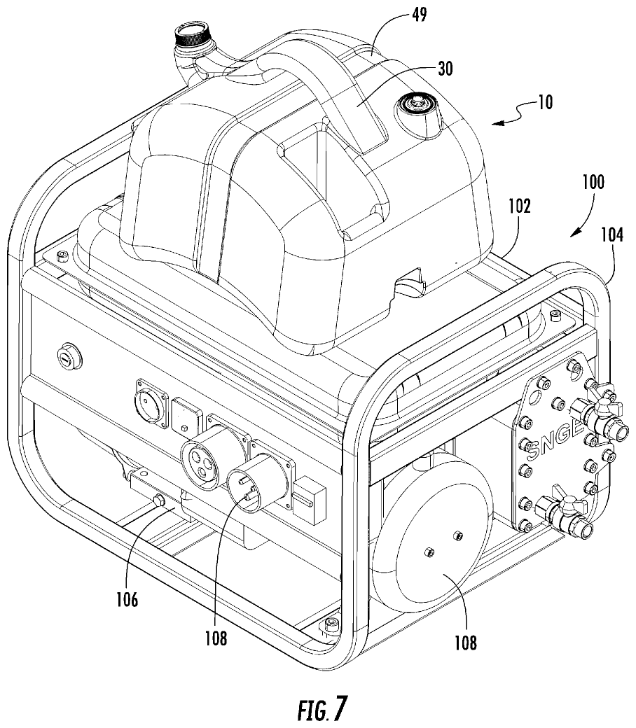

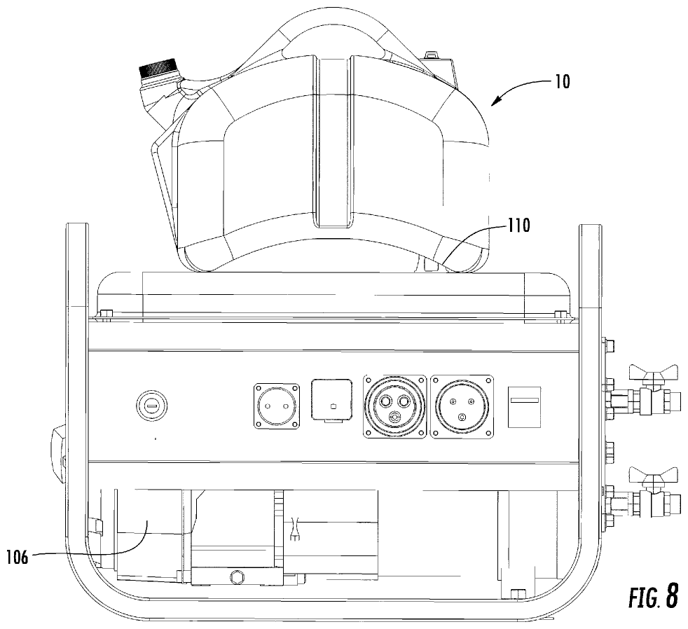

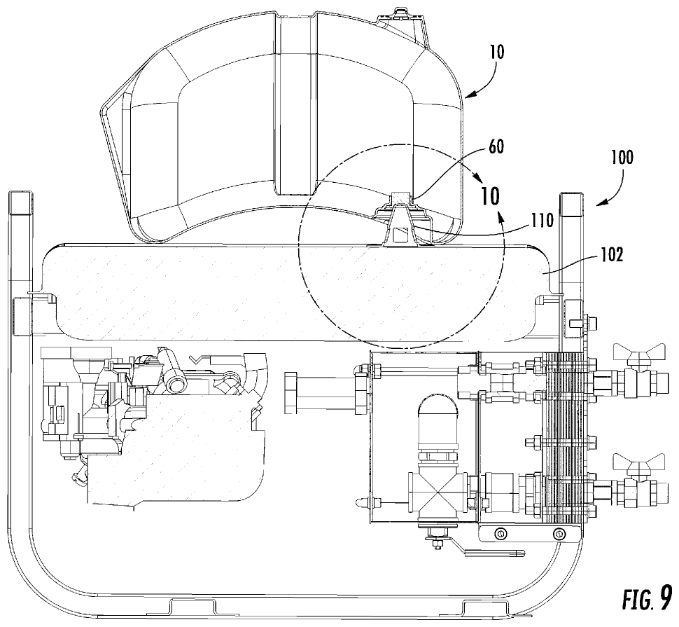

Referring to FIGS. 7-10, depicted is the storage tank 10 positioned on the top of a generator 100 to supplement the generator fuel tank 102. The generator 100 that is depicted is a conventional generator having a support base 104 with an internal combustion engine 106 for operating an electrical coil to provide electrical power through a receptacle 108. In this embodiment, a gas cap coupler 110 is attached to the generator fuel tank 102 which interfaces with the fuel outlet coupler 60 to displace a check valve 61, allowing fluid flow. The gas cap coupler 110 may frictionally engage the fill port of an adjoining storage tank or be incorporated into a threaded cap. For instance, the gas cap coupler could be placed on the fill port of a generator, wave runner, tractor, and so forth to allow fluid transfer. The use of the instant invention contemplates the additional fuel storage need for generators running continuously, or wave runners to extend refueling periods. The fluid fill port threaded opening 24 provides a fluid fill port as well operates as the out when the tank is used in a conventional manner. The fluid fill portion provides a sealable opening for accessing the reservoir formed by the tank walls 14, 16. The fluid inlet coupler 36 secured to the top side 12 employs the check valve 61, providing single directional flow and allowing fluid to enter the reservoir when activated by an adjoining outlet coupler 60 which is secured to the bottom side 22; the fluid outlet coupler 60 having a single directional flow which allows fluid to exit when the coupler 60 is activated. As further illustrated in FIG. 11, the storage tank 10 is constructed and arranged to nest in a stacked position. When the fluid fill ports or openings 24 and 24′ are in alignment, fluid will flow from the upper tank 10′ to the lower tank 10. The couplers 36 and 60 provide a temporary seal between the tanks.

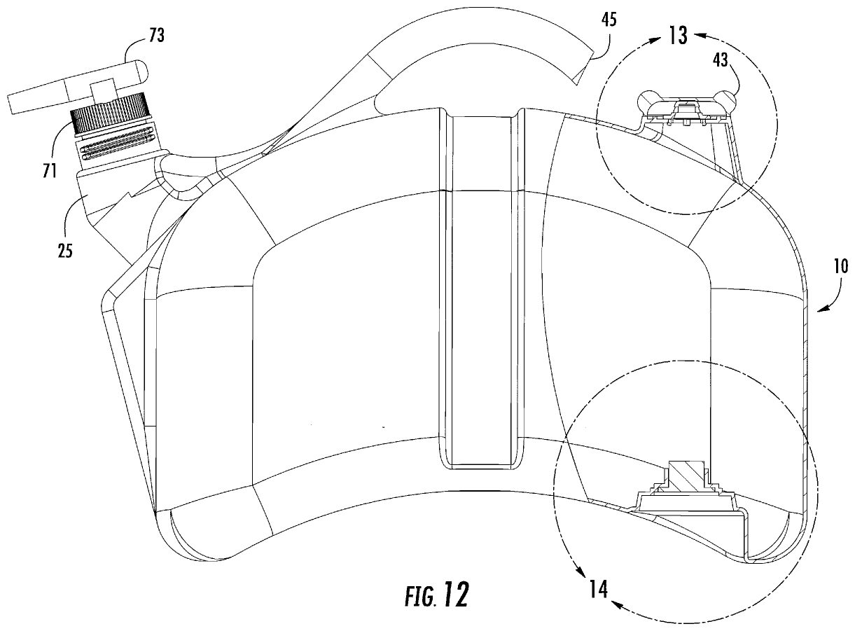

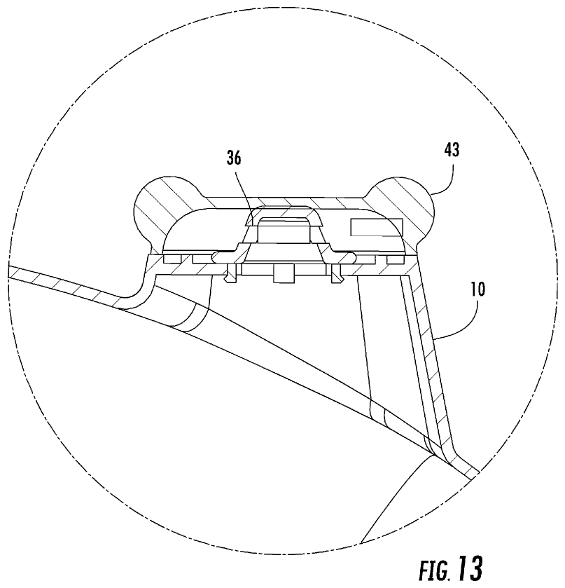

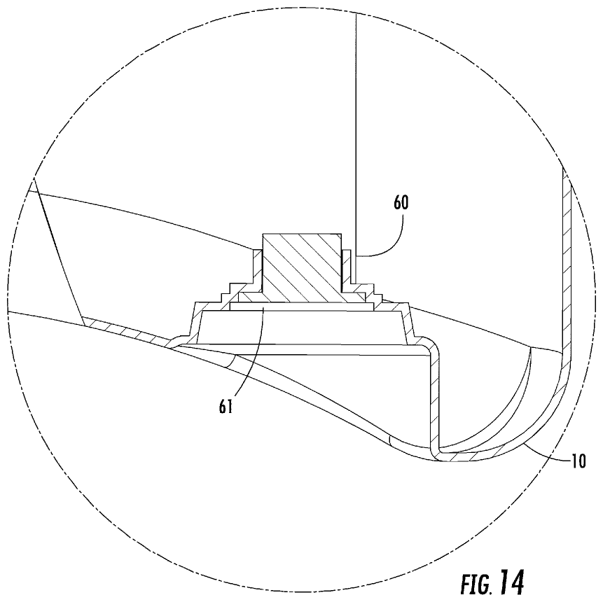

Referring to FIGS. 12-14, the tank 10 having threaded fluid fill port 24 may include a threaded cap 71 to support a spigot 73 which makes it convenient when the tank 10 is used dispense fluid at a low flow rate, such as when the tank is used to store potable water. The integrated handle 30 providing an anti-glug tube 45 to permit fluid dispensing without an associated air lock.

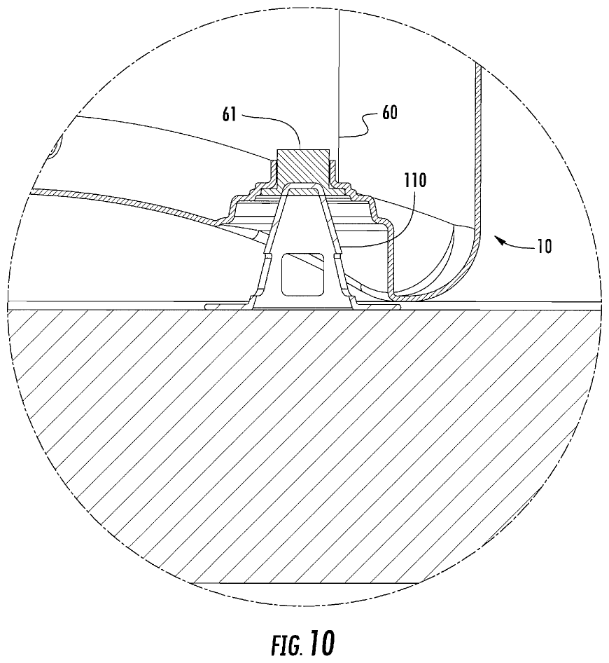

The fuel outlet coupler 60 is illustrated with the check valve 61 in a no-flow position, as compared with FIG. 10 depicting the check valve 61 in a flow position. The quick connect fluid inlet coupler 36 is illustrated with a protective cap 43 to protect from contamination with the coupler 36 is not in use.

The term “coupled” is defined as connected, although not necessarily directly, and not necessarily mechanically. The use of the word “a” or “an” when used in conjunction with the term “comprising” in the claims and/or the specification may mean “one,” but it is also consistent with the meaning of “one or more” or “at least one.” The term “about” means, in general, the stated value plus or minus 5%. The use of the term “or” in the claims is used to mean “and/or” unless explicitly indicated to refer to alternatives only or the alternative are mutually exclusive, although the disclosure supports a definition that refers to only alternatives and “and/or.”

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements, possesses those one or more steps or elements, but is not limited to possessing only those one or more elements. Likewise, a step of a method or an element of a device that “comprises,” “has,” “includes” or “contains” one or more features, possesses those one or more features, but is not limited to possessing only those one or more features. Furthermore, a device or structure that is configured in a certain way is configured in at least that way, but may also be configured in ways that are not listed.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A storage tank allowing fluid transfer comprising:
a tank defined by a top side, a first side wall, a second side wall, a front wall, a rear wall, and a bottom side, forming a reservoir for storage of fluids therein;
a fluid fill port providing a sealable opening for accessing said reservoir;
a fluid inlet coupler secured to said top side, said fluid coupler having a single directional flow allowing fluid to enter said reservoir when activated;
a fluid outlet coupler secured to said bottom side, said fluid outlet coupler having a single directional flow allowing fluid to exit said reservoir when activated;
wherein said storage tank is constructed and arranged to have said fluid outlet coupler releasably secured to a base tank to activate a fluid inlet coupler whereby fluid from said storage tank will flow to said base tank.

2. The storage tank according to claim 1 wherein said fluid outlet coupler provides a temporary seal to a fluid inlet coupler.

3. The storage tank according to claim 1 wherein said top side of said tank has a convex shape wherein the overall top surface is curved outward, and said bottom surface of said tank has a concave shape wherein the overall bottom surface is curved inward.

4. The storage tank according to claim 3 wherein said convex shape of said top surface is constructed and arranged to cause an alignment and nesting with said concave shape of said bottom surface of an adjoining tank.

5. The storage tank according to claim 4 wherein said alignment allows a fluid outlet coupler mounted to the bottom surface of a first tank to interact with a fluid inlet coupler of a second tank positioned beneath said first tank, wherein fluid from said first tank flows to said second tank through said outlet and said inlet coupler.

6. The storage tank according to claim 1 wherein said top side of said tank includes a recessed track for receipt of a mounting strap.

7. The storage tank according to claim 6 wherein said first side surface and said second side surface include a recessed track in continuance of said top side recessed track for receipt of said mounting strap.

8. The storage tank according to claim 1 wherein said bottom surface includes a first and second receiving indent, said first receiving indent for receipt of an adjoining fuel fill port, aligning said outlet coupler with the inlet coupler of an adjoining tank to permit fluid transfer, said second receiving indent for receipt of an adjoining fuel fill port aligning said outlet with a protected area to prevent fluid transfer.

9. The storage tank according to claim 1 wherein said upper surface includes a handle extending from said fluid fill port to a position adjacent said rear side wall, said handle including a vent thereby providing an anti glug vent.

10. A storage tank having automatic fluid transfer comprising:
a tank defined by a convex top side, a first side wall, a second side wall, a front wall, a rear wall, and a concave bottom side, forming a reservoir for storage of fluids therein;
a fluid fill port providing a sealable opening for accessing said reservoir;
a fluid inlet coupler secured to said top side, said fluid coupler having a single directional flow allowing fluid to enter said reservoir when activated;
a fluid outlet coupler secured to said bottom side, said fluid outlet coupler having a single directional flow allowing fluid to exit said reservoir when activated;
a first and second receiving indent, said first receiving indent formed into said bottom surface for receipt of an adjoining fuel fill port and aligning said outlet coupler with the inlet coupler of an adjoining tank to permit fluid transfer, said second receiving indent for receipt of an adjoining fuel fill port aligning said outlet with a protected area to prevent fluid transfer;
wherein said storage tank is constructed and arranged to have said fluid outlet coupler releasably secured to a base tank having a fluid inlet coupler whereby fluid from said storage tank will flow to said base tank.

11. The storage tank according to claim 10 wherein said convex shape of said top surface is constructed and arranged to cause an alignment and nesting with said concave shape of said bottom surface of an adjoining tank.

12. The storage tank according to claim 10 wherein said alignment allows a fluid outlet coupler mounted to the bottom surface of a first tank to interact with a fluid inlet coupler of a second tank positioned beneath said first tank, wherein fluid from said first tank flows to said second tank through said outlet and said inlet coupler.

13. The storage tank according to claim 10 wherein said top side of said tank includes a recessed track for receipt of a mounting strap.

14. The storage tank according to claim 13 wherein said first side surface and said second side surface include a recessed track in continuance of said top side recessed track for receipt of said mounting strap.

15. The storage tank according to claim 10 wherein said upper surface includes a handle extending from said fluid fill port to a position adjacent said rear side wall, said handle including a vent thereby providing an anti glug vent.
